(19) United States
(12) Patent Application Publication
(10) Pub. No.: US 2005/0071749 A1
(43) Pub. Date: Mar. 31, 2005

(54) Developing and using user interfaces with views

(76) Inventors: Bjoern Goerke, Muehlhausen (DE); Jens Baumgart, Wiesloch (DE); Jens Ittel, Rauenberg (DE); Markus Cherdron, Muehlhausen (DE); Stefan Beck, Leimen (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/781,271

(22) Filed: Feb. 17, 2004

Related U.S. Application Data
(63) Continuation-in-part of application No. 10/676,824, filed on Sep. 30, 2003, now abandoned.

(51) Int. Cl. G06F 15/00

(52) U.S. Cl. 715/501.1

(57) ABSTRACT

Methods and apparatus, including computer program products, for developing user interfaces with views and executing applications with such user interfaces. User input is received specifying a view composition. The view composition includes a set of views, a layout of the views, and at least one navigation link. Each view includes a layout of one or more user interface elements selected from a set of user interface elements. Each navigation link specifies a potential transition from one view in the set of views to another view in the set of views. The view composition is stored in a repository. A user interface can be generated according to the layout of views specified in the view composition, and modified based on the navigation links. In some embodiments, views can be nested. In addition, view compositions can be associated with application components, can include views from nested components, and can be modified dynamically.

### CROSS-REFERENCE TO RELATED APPLICATION

This application is a continuation-in-part of U.S. application Ser. No. 10/676,824, filed on Sep. 30, 2003.

### BACKGROUND

The present invention relates to application programming and execution.

Applications can be developed using various architectures, including, for example, a model-view-controller (MVC) architecture. Applications built using the MVC architecture typically include three different types of parts—models, views, and controllers. Models store data (e.g., application data). Views display information from a model. Controllers, which can relate to multiple views, receive events, for example, raised by a user interacting with a view to manipulate a model. An application can have multiple models, and each model can be associated with multiple controllers and multiple views. The models and the controllers typically include application code. When changes occur in a model, the model can update its views. Data binding can be used for data transport between a view and its associated model or controller. For example, a table view can be bound to a corresponding table in a model or controller. Such a binding indicates that the table is to serve as the data source for the table view, and consequently that the table view is to display data from the table. Continuing with this example, the table view can be replaced by another view, such as a graph view. If the graph view is bound to the same table, the graph view can display the data from the table without requiring any changes to the model or controller.

Application development is often divided into two general stages: a design time stage and a runtime stage. The design time stage can include designing the views of an application (including the layout of the user interface elements in each view), modeling of the application flow (including the selection of the views to displayed), designing one or more models, and creating and editing other application elements, such as controllers and storage areas (e.g., contexts). The design time stage can also include the creation of bindings and/or mappings between various application entities (e.g., user interface elements in views, data elements in contexts, and data elements in models), as well as bindings between application entities and data types defined in a data type repository.

The information created during the design time can include application metadata, which can be stored in a metadata repository and used as input to the runtime stage. During the runtime stage, the application metadata can be used to generate the actual runtime code of an application. In some implementations, the application metadata is platform independent, and the generated runtime code is platform specific. The runtime code can be executed in a runtime environment that provides a general framework for running applications. For example, the runtime environment can provide services for deploying and maintaining applications, as well as features such as a caching mechanism that can be used to improve performance, and automatic input assistance and default error handling that is based on the declared application metadata.

Regardless of which application architecture is used, it is often desirable to structure an application (including, for example, the models, views, and controllers that make up an MVC application) into reusable entities or components. The components can be embedded into an application, or, in some implementations, into other components, thus creating hierarchies of nested components.

### SUMMARY OF THE INVENTION

The present invention provides methods and apparatus, including computer program products, that implement techniques for developing user interfaces through the use of views and for executing applications that include such user interfaces.

In one aspect, the techniques feature receiving user input that specifies a view composition, and storing the view composition in a repository. The view composition includes a set of views, a layout of the views, and at least one navigation link. Each view in the set of views includes a layout of one or more user interface elements selected from a set of user interface elements. Each navigation link specifies a potential transition from one view in the set of views to another view in the set of views.

In another aspect, the techniques feature generating a user interface with a layout of one or more views from a set a views. The layout and the set of views are specified in a view composition. Each view in the set of views includes a layout of one or more user interface elements selected from a set of user interface elements. The user interface is modified based on at least one navigation link specified in the view composition. Each navigation link in the view composition associates a first view in the set of views with a second view in the set of views.

In another aspect, the techniques feature storing a design time representation of a visual interface for a computer program on a computer readable medium. The visual interface includes a set of views, a layout of the views, and at least one navigation link. Each view in the set of views includes a layout of one or more user interface elements selected from a set of user interface elements. Each navigation link specifies a potential transition from a first view in the set of views to a second view in the set of views.

Advantageous implementations can include one or more of the following features. The set of user interface elements can include one or more of input user interface elements, view user interface elements, and container user interface elements. Additional user input with a specification of one or more property settings for at least one of the one or more user interface elements can be received. The user input can be provided by a user through interface controls provided in at least one graphical user interface.

Each navigation link can include an association between an exit point in a first view and an entry point in a second view. The exit point can contain a definition of an event that can be raised in order to trigger the navigation link, and the entry point can contain an event handler corresponding to that event.

The layout of the views can include a pre-defined layout. The layout of the views can also include a nesting of one or more views from the set of views inside an enclosing view from the set of views. The nesting can include an association between the nested views and a view container user interface element in the enclosing view. The nesting can also include an association between the nested views and a pre-defined set of view areas in the enclosing view.

The layout of the views can contain a specification of a view area for displaying at most one view at a time, and an association between the view area and two or more views from the set of views. One of the two or more views can be designated as a default view to display in the view area.

The view composition can be associated with a reusable component. At least one of the views in the set of views can be defined in a second, distinct view composition associated with a second, distinct reusable component.

An XML representation of the view composition can be generated and stored in the repository.

A navigation link can associate a first view in the set of views with a second view in the set of views, and modifying the generated user interface can include invoking an event handler implemented in an entry point associated with the second view. Modifying the generated user interface can also include displaying the second view in the user interface.

The layout of the views can include a specification of a view area for displaying at most one view at a time, and an association between the view area and the first and second views associated by the navigation link. In such an implementation, modifying the generated user interface can include displaying the second view in the view area and hiding the first view. The layout of the views can include a nesting of the second view inside an enclosing view in the set of views. In such an implementation, modifying the user interface can also include displaying the enclosing view in the user interface. Moreover, displaying the enclosing view can include displaying a third view that is contained in the enclosing view.

A view composition can be modified. Modifying a view composition can include specifying a new view and a new navigation link between the new view and one of the views in the set of views. The view composition can be associated with a reusable component, and the new view can be defined in a second, distinct view composition associated with a second, distinct reusable component.

A view layout can include a specification of a view area for displaying at most one view at a time, an association between the view area and two or more views from the set of views, and a designation of one of the two or more views as a default view to display in the view area. A view layout can also include a nesting of one or more views from the set of views inside an enclosing view from the set of views.

The invention can be implemented to realize one or more of the following advantages. The visual interface for an application can be designed by using views and visual interfaces defined by components embedded by the application. Components can embed other components, and visual interfaces defined by the embedded component can be used by the embedding component. A visual interface can embed one or more views, each of which can include further embedded or nested views, and navigation links can be used to define transitions between the views. Because components can be reused, the views associated with the components can also be reused. View compositions can be defined at design time and used to generate view assemblies at runtime. New view assemblies can be created dynamically at runtime through the runtime modification of view compositions. One implementation of the invention provides all of the above advantages.

These general and specific aspects can be implemented using a method, a system or apparatus, a computer program product with instructions operable to cause data processing apparatus to carry out the above techniques, or any combination of methods, systems, or computer programs. The details of one or more implementations of the invention are set forth in the accompanying drawings and in the description below. Further features, aspects, and advantages of the invention will be apparent from the description, the drawings, and the claims.

### BRIEF DESCRIPTION OF THE DRAWINGS

FIG. 1 illustrates an example system for developing and using visual interfaces.

FIG. 2 is a block diagram of a sample view.

FIG. 3 illustrates a visual interface with multiple views that are linked together using navigation links.

FIG. 4 is a flow diagram illustrating a method for designing a visual interface for an application.

FIG. 5A-5E illustrate example viewsets.

FIG. 6 is a flow diagram illustrating a method for designing a visual interface for embedded components.

FIG. 7 illustrates a design time representation of a visual interface for a sample shopping application.

FIG. 8 is a flow diagram illustrating a method for displaying a visual interface at runtime.

FIGS. 9A-9E illustrate runtime representations of the visual interface for the sample shopping application.

Like reference numbers and designations in the various drawings indicate like elements.

### DETAILED DESCRIPTION

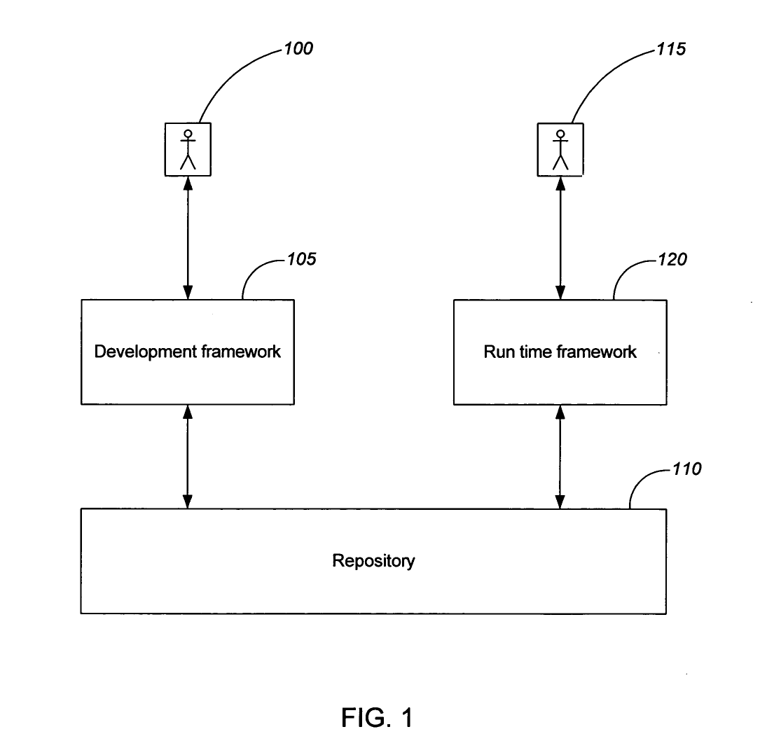

FIG. 1 illustrates an example environment for developing the visual interface of a software application, and presenting the visual interface at runtime. The system includes a development framework 105 and a runtime framework 120. An application developer 100 uses the development framework 105 at design time to specify the visual interface, and stores the visual interface in a repository 110. At runtime, the runtime framework 120 retrieves the specified visual interface from the repository 110 and presents it to an application user 115.

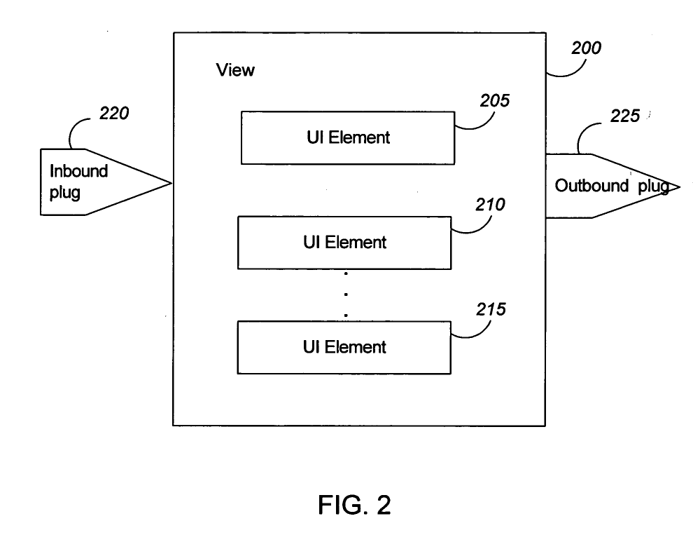

The visual interface of a software application can be made up of one or more views arranged in a specific layout. FIG. 2 is a block diagram of a sample view 200. The view 200 specifies a layout of one or more user interface (UI) elements (e.g., UI elements 205, 210, and 215). UI elements can include input UI elements, view UI elements, and container UI elements. An input UI element is a control or other UI element that can receive input from a user (e.g., a button, a drop down menu, a text field, or a table UI element). A view UI element is used to display data (e.g., an image view, a text view, or a caption or label). A container UI element, described below, is used to include other UI elements or views (e.g., a scroll container UI element can include a scroll bar). Container UI elements can specify layouts for the included UI elements or views.

A visual interface that embeds the view 200 can define a view area to be used for displaying the view 200. The view area can be used to display multiple views; however, only one view can be displayed in the view area at a given time. One of the views can be designated as a default view that is initially displayed in the view area.

Although a visual interface can have more than one view, generally, only some of the views are visible at any time. Which views are visible in the visual interface can change, e.g., in response to input from a user. Navigation links can be used by an application developer to specify view changes or transitions.

Each view can have one or more inbound plugs (e.g., inbound plug 220) and one or more outbound plugs (e.g., outbound plug 225). An inbound plug is an entry point for a view, and an outbound plug is an exit point for a view. In one implementation, each outbound plug defines an action or event that a view can raise in order to initiate a view change (i.e., a transition to one or more target views), and the corresponding event handlers for such actions or events are implemented in the inbound plugs of the target views. Such event handlers, which can be application-specific, are executed when the inbound plugs in which the event handlers are located are called (before the corresponding views are displayed). An application can use such event handlers to initialize the corresponding views. The event handlers of a view's inbound plugs can be specified in a view controller associated with the view. The view controller can also contain event handlers for the UI elements in the view, as well as the presentation logic for the view.

A navigation link establishes a potential transition from a source view to one or more target views by associating an outbound plug of the source view with an inbound plug in each target view. In one implementation, a developer specifies such a potential transition at design time by drawing a navigation link connecting the outbound plug of the source view to an inbound plug in each target view.

Navigation links can be processed at runtime to effect the specified view transitions or changes. For example, a navigation link can be triggered by calling an outbound plug connected to the navigation link, or by raising an action or event defined in such an outbound plug. Triggering the navigation link results in a call to the view controller of a target view that has an inbound plug connected to the navigation link, and possibly in the display of the target view. The target view may not be displayed if, for example, the event handler associated with its inbound plug calls an outbound plug of the target view to trigger further navigation links. In some circumstances, triggering the navigation link to the target view can also result in the hiding of the view associated with the outbound plug (the source view). This can happen, for example, if the source view and the target view are in the same view area, or if the view area in which the source view is located is no longer visible as a result of the navigation.

An application or a component can include any number of views at design time, a subset of which may be displayed at runtime. The set of views associated with an application or a component is referred to as a view composition. A view assembly is a set of views that are actually displayed at runtime. That is, a view assembly consists of views from the view composition that are selected for display at a certain point in time. When a navigation link is processed at runtime, a view in a current view assembly may be replaced by one or more destination views from the view composition.

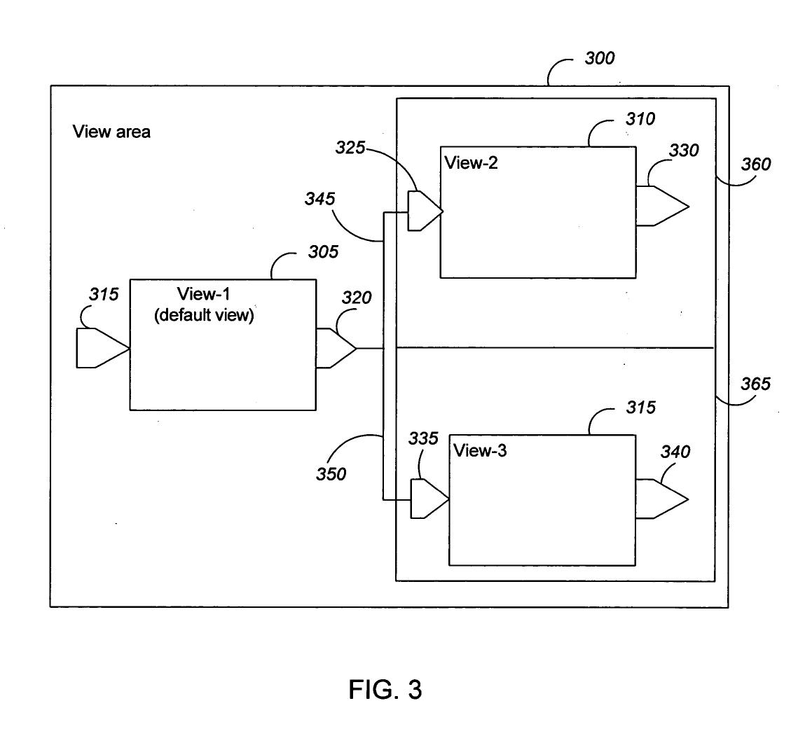

FIG. 3 illustrates a visual interface with multiple views that are linked together using navigation links. Each navigation link connects an inbound plug to an outbound plug. The visual interface includes a view area 300. View area 300 includes a view 305 that is the default view for the view area 300. View area 300 also includes view areas 360 and 365, which can be specified as part of a viewset (e.g., a grid viewset with one column and two rows). (Viewsets are discussed below.) Alternatively, view areas 360 and 365 can be specified as part of two view containers included in another view.

View areas 360 and 365 include views 310 and 315, respectively. View 305 has an inbound plug 315 and an outbound plug 320. View 310 has an inbound plug 325 and an outbound plug 330. View 315 has an inbound plug 335 and an outbound plug 340. Outbound plug 320 is connected to inbound plug 325 by a navigation link 345, and outbound plug 320 is connected to inbound plug 335 by a navigation link 350. At runtime, calling the outbound plug 320 when view 305 is displayed in the view area 300 causes any application-specific event handlers associated with the inbound plugs 325 and 335 to be called, and views 310 and 315 (as well as an encompassing viewset or view) to be displayed.

Applications can make use of components that contain view compositions. Components can embed other components, such that a first component can interact with and make use of a second, embedded, component. The view composition of the first component can include views from the second component. Similarly, the view composition of an application can include views from the components used by the application. In addition, an application developer can design application specific views that are part of the application's view composition.

In one implementation, the design time environment and the runtime environment provide and use a special view called the empty view. The empty view contains no UI elements, has no associated view controller, and has only one inbound plug. (In contrast, other views contain a layout of at least one UI element.) At runtime, the empty view is used to fill a view area where no view is to be displayed. In addition, the empty view can also be used to fill a view area in place of a component view where the component has not been instantiated yet. In one implementation, the empty view is substituted for the component view by the runtime framework. For example, in an application for taking sales orders, a view area may be reserved for showing a view associated with a shopping cart component (a reusable component that maintains a list of items to be purchased by a customer). If the shopping cart component has not been initiated yet, e.g., because the customer has not selected any items, the view area associated with the shopping cart is filled with empty space by displaying an empty view.

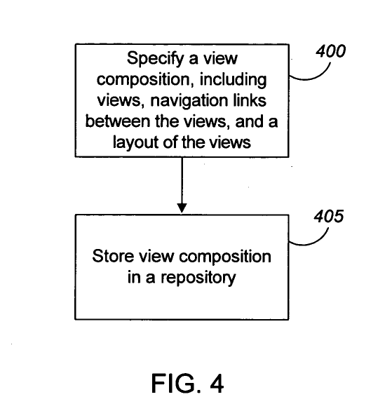

FIG. 4 is a flow diagram illustrating a method for designing a visual interface for an application. An application developer specifies a view composition for the application (step 400). This step can include specifying the views included in the view composition, navigation links between the views, and a layout of the views in a visual interface. The specification of the layout can include a specification of groups of views that are to be displayed in one or more view areas, where only one view is visible in a view area at any given time. Together, the views, the navigation links, and the layout define the view composition. The view composition can be stored in a repository (step 405), using, for example, an XML representation.

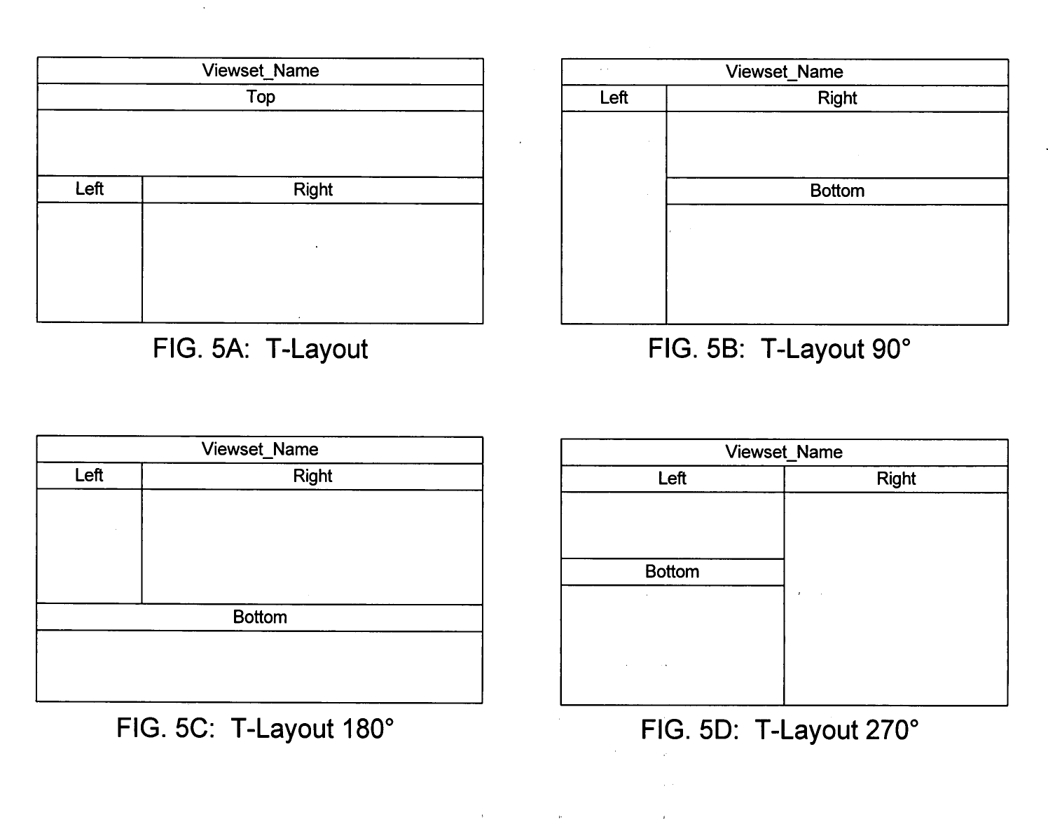

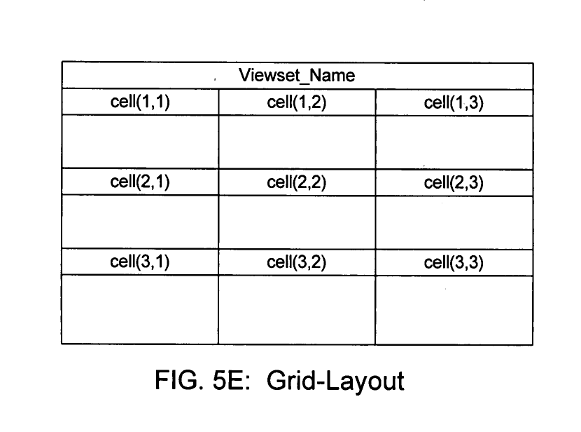

In one implementation, the layout of the views in step 400 can be specified using viewsets. Viewsets are pre-defined layouts provided by the development framework. Each viewset specifies a layout of view areas included in the viewset. Views can be grouped and laid out in step 400 by selecting a viewset and using an affiliated viewset tool to associate specified views with the view areas in the viewset. Examples of viewsets include a T-Layout (FIG. 5A), a T-Layout 90° (FIG. 5B), a T-Layout 180° (FIG. 5C), a T-Layout 270° (FIG. 5D), and a Grid-Layout (FIG. 5E). Viewsets can also be used to nest views (e.g., if a viewset is used to specify a layout of view areas in a first view, the views associated with those view areas will be enclosed within first view).

Views can also be grouped and laid out using view container UI elements (view containers). View containers are UI elements that can contain other views. A view area is provided for each view container, and one or more views can be associated with the view area. In this manner, views can be embedded or nested within each other.

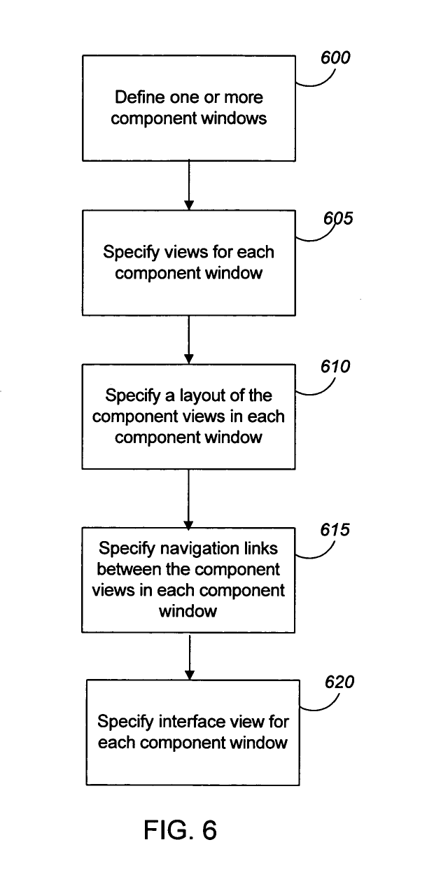

FIG. 6 is a flow diagram illustrating a method for designing a visual interface for a component. One or more component windows are defined for the component (step 600), and views to be included in each component window are specified (step 605). The component views can be views defined in the component, or views defined as part of another component embedded within the component. A layout of the views for each component window is specified (step 610), including a grouping of the views in each component window, and navigation links are specified between the views for each component window (step 615).

An interface view can then be specified for each component window (step 620). The interface views define the visual representation of the component. An application or a higher-level component can embed one of the component windows by embedding the associated interface view. In this manner, the component views can be embedded in and used by the application or the higher-level component.

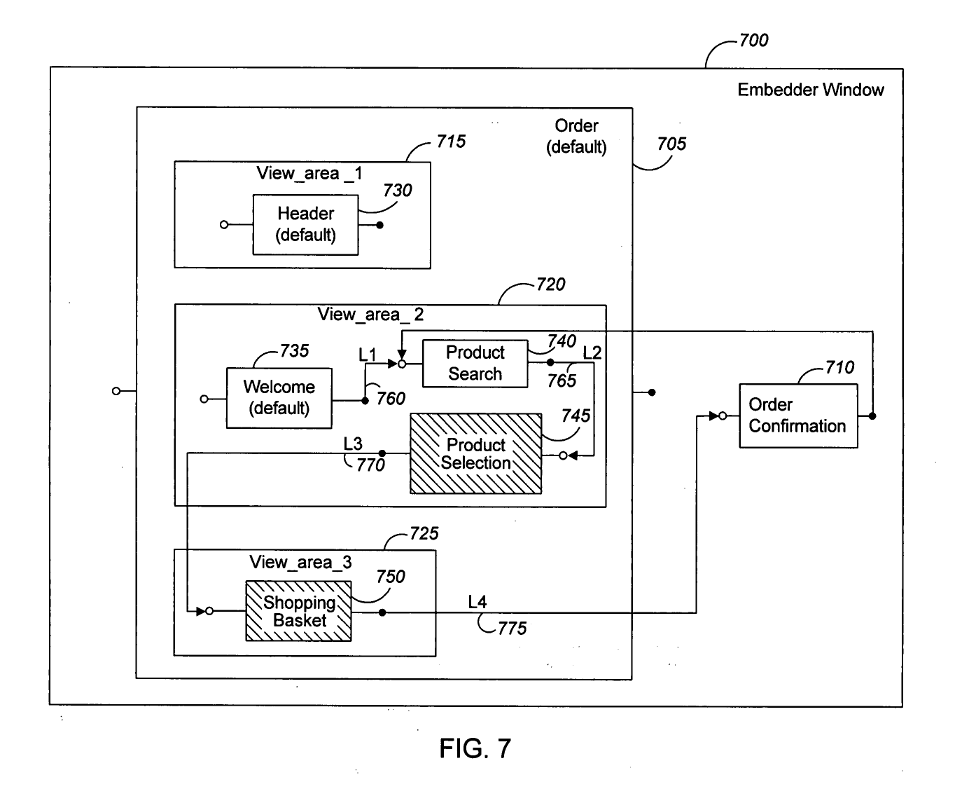

FIG. 7 is a design time representation of a visual interface for an example shopping application. The visual interface is displayed in a view area 700. The view area 700 includes a viewset 705 (Order) and a view 710 (Order Confirmation). Only one of the viewset 705 or the view 710 is visible in the view area 700 at a given time. The viewset 705 includes three view areas—view_area_1 715, view_area_2 720, and view_area_3 725. The view_area_1 715 displays a view 730 (Header), and the view_area_3 725 displays a view 750 (Shopping Basket). The view_area_2 720 includes three views 735 (Welcome), 740 (Product Search), and 745 (Product Selection). Only one of the views 735, 740, or 745 is visible in the view area 720 at a given time.

The view 745 (Product Selection) and the view 750 (Shopping Basket) are interface views specified by an embedded component. The views 745 and 750 behave like any other views in the view area 700 with regard to visibility; however, their view controllers are part of the embedded component, and as such, the controllers are not directly accessible by the shopping application.

The viewset 705 is designated as the default view for the view area 700, and as such, the viewset 705 is initially displayed in the view area 700. The view 730 is designated as the default view for view_area_1 715, and the view 735 is designated as the default view for view_area_2 720. Accordingly, the views 730 and 735 are initially displayed in view_area_1 715 and view_area_2 720, respectively.

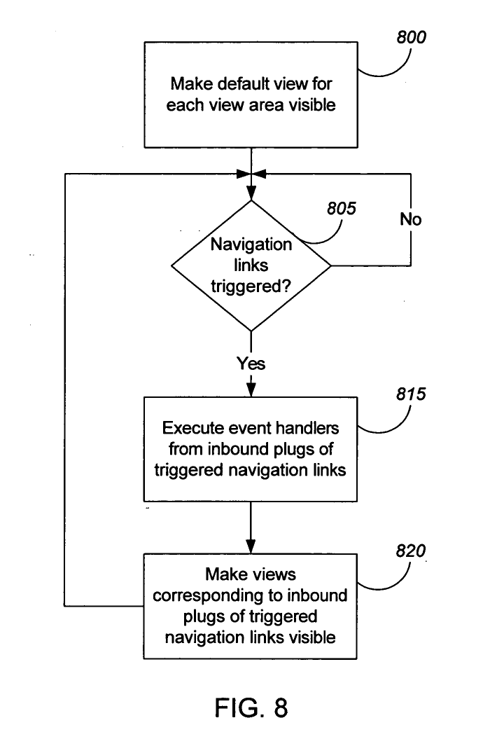

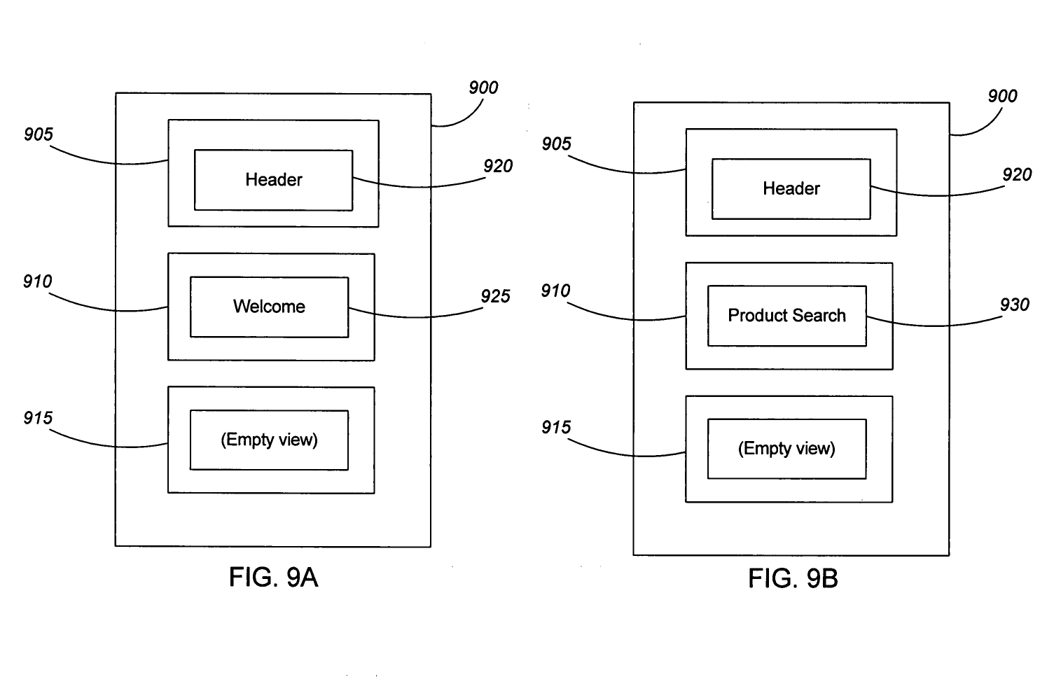

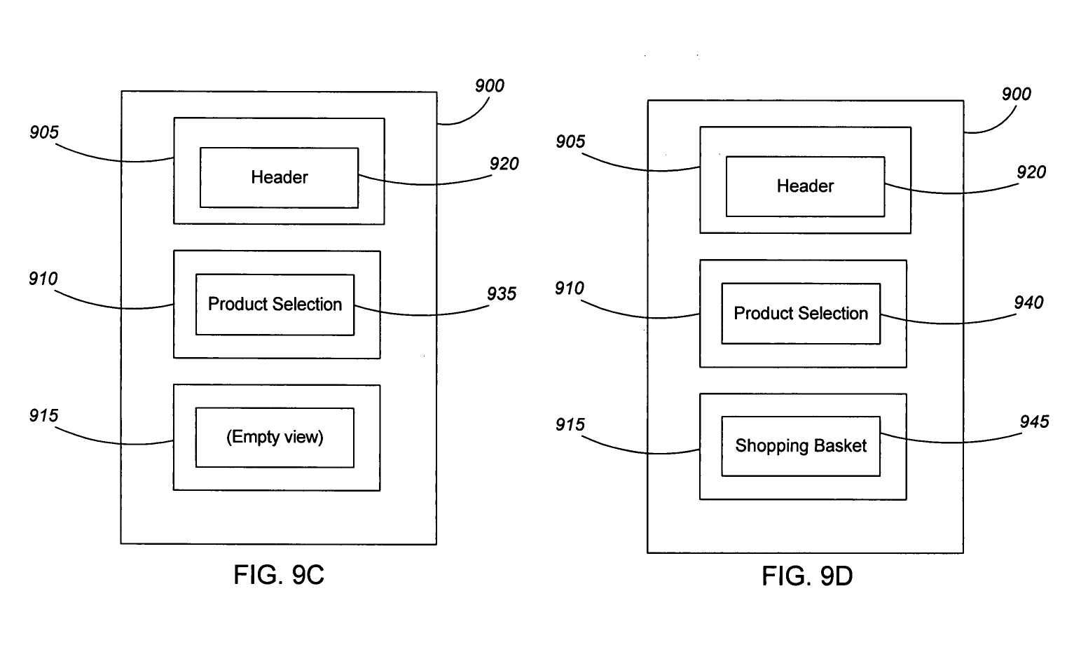

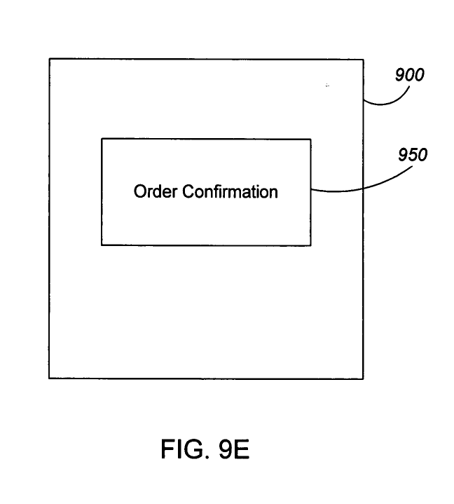

At design time, the application developer specifies transitions between the views of the shopping application using navigation links. In FIG. 7, the black disks represent outbound plugs and the white disks represent inbound plugs for the views. Navigation link L1 760 specifies a transition from view 735 (Welcome) to view 740 (Product search). Navigation link L2 765 specifies a transition from view 740 (Product Search) to view 745 (Product Selection). Navigation link L3 770 specifies a transition from view 745 (Product Selection) to view 750 (Shopping Basket). Navigation link L4 775 specifies a transition from view 750 (Shopping Basket) to view 710 (Order Confirmation). Navigation link L5 780 specifies a transition from view 710 (Order Confirmation) to view 740 (Product Search). The operation of these transitions is explained with reference to FIGS. 8 and 9A-9E below.

FIG. 8 is a flow diagram illustrating a method for displaying a visual interface at runtime based on a design time representation of the visual interface. The designated default view for each view area is first made visible (step 800). The empty view is displayed for a view area that does not have a designated default view. If one or more navigation links are triggered (“yes” branch of decision step 805), the event handlers for the inbound plugs of the triggered navigation links are executed (step 815), and the views corresponding to the inbound plugs of the triggered navigation links (the target views) are made visible (step 820). Making the target views visible may require higher level “parent” views or viewsets to be made visible. For example, assuming that view A contains view B and view B contains view C, if view C must be made visible as a result of a triggered navigation link, views A and B must also be made visible. Moreover, making the target views visible may in some circumstances result in the hiding of some views or viewsets. Specifically, any views or viewsets that are in the same view area as a target view are no longer displayed. As an example, if the navigation link L5 in FIG. 7 is triggered, the source view 710 is no longer displayed, as it is in the same view area 700 as the target view. In this scenario, the source view 710 is replaced by the target view 740, as well as the parent viewset 705 and its included views.

FIGS. 9A-9E illustrate runtime representations of the visual interface for the example shopping application of FIG. 7. FIG. 9A shows the visual interface that is initially presented by the shopping application in a presentation area 900, before any user input is received. The viewset 705 is initially made visible in the presentation area 900 since it is the default view for the view area 700. The designated default view for each view area in the viewset 705 is also made visible—i.e., the view 730 is initially made visible in the view_area_1 715, and the view 735 is initially made visible in the view_area_2 720. The empty view is initially displayed in the view_area_3 725, as there is no designated default view for that view area.

The displayed visual interface includes three presentation areas 905, 910, and 915, corresponding to the view areas 715, 720, and 725 specified at design time. Header view 920, corresponding to view 730, is displayed in the presentation area 905, and Welcome view 925, corresponding to view 735, is displayed in the presentation area 925. The empty view, i.e., a blank view, is displayed in the presentation area 915 because the corresponding view area 725 does not have a designated default view.

FIG. 9B shows the visual interface that is presented after the navigation link L1 760 is triggered (e.g., as a result of the user clicking on Welcome view 925). The Product Search view 930, corresponding to view 740, is displayed in the presentation area 910, and the Welcome view 925 is no longer displayed, since its corresponding view 735 is in the same view area 720 as the view 740. The Product Search view 930 provides a visual interface that the user can use to search for a desired product.

FIG. 9C shows the visual interface that is presented after the navigation link L2 765 is triggered (e.g., as a result of the user initiating a search using the Product Search view 930). The Product Selection view 935, corresponding to view 745, is displayed in the presentation area 910, and the Product Search view 930 is no longer displayed, since its corresponding view 740 is in the same view area 720 as the view 745. The Product Selection view 935 displays the results of the search and provides a visual interface that the user can use to select a desired product for purchase.

FIG. 9D shows the visual interface that is presented after the navigation link L3 770 is triggered (e.g., as a result of the user selecting a product from the Product Selection view 935 for purchase). The Shopping Basket view 945, corresponding to view 750, is displayed in the presentation area 915 instead of the empty view. In this case, the Product Selection view 940 is still visible in the presentation area 910, because its corresponding view 745 is in a different view area (view area 720) than the view area containing view 750 (view area 725). The Shopping Basket view 945 displays products selected by the user for purchase, and provides a visual interface that the user can use to checkout.

FIG. 9E shows the visual interface that is presented after the navigation link L4 775 is triggered (e.g., as a result of the user initiating a checkout operation using the visual interface provided by the Shopping Basket view 945). The visual interface displays the Order Confirmation view 950, corresponding to view 710, in presentation area 900, and the views 920, 940, 945 in the presentation areas 905, 910, and 915 (corresponding to the views 730, 745, and 750 in the viewset 705) are no longer displayed, since the view 710 is in the same view area 700 as the viewset 705. The Order Confirmation view 950 allows the user to confirm the purchase.

The Order Confirmation view 950 also allows the user to continue searching for more products by triggering the navigation link L5 780. If the navigation link L5 780 is triggered, the visual interface reverts to a visual interface similar to the one displayed in FIG. 9B. The Order Confirmation view 950 is no longer displayed in the presentation area 900. In its place, the Product Search view 930 (corresponding to the view 740) is displayed in the presentation area 910. In addition, all the views in the parent viewset 705 are also made visible—i.e., the Header view 920 (corresponding to the view 730) is displayed in the presentation area 905, and the Shopping Basket view 945 (corresponding to the view 750) is displayed in the presentation area 915.

In some implementations, view compositions created at design time can be modified at runtime to create new, dynamic view compositions. For example, the shopping cart application discussed above may give a user an option to view information from another application within the user interface of the shopping cart application. The user may select to view, for example, information from an inventory application. In this scenario, the view composition of the shopping cart application can be modified to include one or more views from the view composition of the inventory application. New navigation links can be added to specify transitions to and from the views from the inventory application, and some of the views from the inventory application can be embedded in views from the shopping cart application.

In addition to adding new views and navigation links, view compositions can also be modified by deleting and/or modifying existing views and navigation links. For example, a user may specify that he does not want to see an order confirmation screen in the shopping cart application, in which case the order confirmation view 710 can be removed from the view composition illustrated in FIG. 7, and the navigation links to and from that view can be adjusted appropriately. If the user later changes his mind and specifies that he does want to see the order confirmation screen, the view 710 can be added back to the view composition and the navigation links can be adjusted accordingly.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results. What is claimed is:

1. A computer program product, tangibly embodied in an information carrier, the computer program product comprising instructions operable to cause data processing apparatus to:
receive user input specifying a view composition, the view composition comprising a set of views, each view in the set of views comprising a layout of one or more user interface elements selected from a set of user interface elements, the view composition further comprising a layout of the views and at least one navigation link, each navigation link specifying a potential transition from a first view in the set of views to a second view in the set of views; and
store the view composition in a repository.

2. The computer program product of claim 1, wherein the set of user interface elements comprises one or more of input user interface elements, view user interface elements, and container user interface elements.

3. The computer program product of claim 1, wherein the instructions are further operable to cause the data processing apparatus to receive further user input, the further user input specifying one or more property settings for at least one of the one or more user interface elements.

4. The computer program product of claim 1, wherein each navigation link comprises an association between an exit point in the first view and an entry point in the second view.

5. The computer program product of claim 4, wherein the exit point comprises a definition of an event that can be raised in order to trigger the navigation link, and the entry point comprises an event handler corresponding to the event.

6. The computer program product of claim 1, wherein the layout of the views comprises a pre-defined layout.

7. The computer program product of claim 1, wherein the layout of the views comprises a nesting of one or more views from the set of views inside an enclosing view from the set of views.

8. The computer program product of claim 7, wherein the nesting comprises an association between the one or more views and a view container user interface element in the enclosing view.

9. The computer program product of claim 7, wherein the nesting comprises an association between the one or more views and a pre-defined set of view areas in the enclosing view.

10. The computer program product of claim 1, wherein the layout of the views comprises a specification of a view area for displaying at most one view at a time, and an association between the view area and two or more views from the set of views.

11. The computer program product of claim 10, wherein one of the two or more views is designated as a default view to display in the view area.

12. The computer program product of claim 1, wherein the instructions are further operable to cause the data processing apparatus to associate the view composition with a reusable component.

13. The computer program product of claim 12, wherein at least one of the views in the set of views is defined in a second, distinct view composition associated with a second, distinct reusable component.

14. The computer program product of claim 1, wherein the user input is provided by a user through interface controls provided in at least one graphical user interface.

15. The computer program product of claim 1, wherein the instructions are further operable to cause the data processing apparatus to generate an XML representation of the view composition, and wherein storing the view composition in the repository comprises storing the XML representation of the view composition in the repository.

16. A computer program product, tangibly embodied in an information carrier, the computer program product comprising instructions operable to cause data processing apparatus to:
generate a user interface comprising a layout of one or more views from a set a views, the layout and the set of views being specified in a view composition, each view in the set of views comprising a layout of one or more user interface elements selected from a set of user interface elements; and
modify the user interface based on at least one navigation link specified in the view composition, wherein each navigation link associates a first view in the set of views with a second view in the set of views.

17. The computer program product of claim 16, wherein modifying the user interface comprises invoking an event handler implemented in an entry point associated with the second view.

18. The computer program product of claim 16, wherein modifying the user interface comprises displaying the second view in the user interface.

19. The computer program product of claim 16, wherein:
the layout of the one or more views comprises a specification of a view area for displaying at most one view at a time, and an association between the view area and the first and second views; and
modifying the user interface comprises displaying the second view in the view area and hiding the first view.

20. The computer program product of claim 18, wherein:
the layout of the one or more views comprises a nesting of the second view inside an enclosing view in the set of views; and
modifying the user interface further comprises displaying the enclosing view in the user interface.

21. The computer program product of claim 20, wherein displaying the enclosing view comprises displaying a third view contained in the enclosing view.

22. The computer program product of claim 16, wherein the instructions are further operable to cause the data processing apparatus to modify the view composition.

23. The computer program product of claim 22, wherein modifying the view composition comprises:
specifying a new view; and
specifying a new navigation link between the new view and one of the views in the set of views.

24. The computer program product of claim 23, wherein the view composition is associated with a reusable component, and wherein the new view is defined in a second, distinct view composition associated with a second, distinct reusable component.

25. A computer readable medium having stored thereon a design time representation of a visual interface for a computer program, the design time representation of the visual interface comprising:
a set of views, each view in the set of views comprising a layout of one or more user interface elements selected from a set of user interface elements;
a layout of the views; and
at least one navigation link, each navigation link specifying a potential transition from a first view in the set of views to a second view in the set of views.

26. The computer readable medium of claim 25, wherein the layout of the views comprises:
a specification of a view area for displaying at most one view at a time;
an association between the view area and two or more views from the set of views; and
a designation of one of the two or more views as a default view to display in the view area.

27. The computer readable medium of claim 25, wherein the layout of the views comprises a nesting of one or more views from the set of views inside an enclosing view from the set of views.

28. A computer-implemented method for developing user interfaces, the method comprising:
receiving user input specifying a view composition, the view composition comprising a set of views, each view in the set of views comprising a layout of one or more user interface elements selected from a set of user interface elements, the view composition further comprising a layout of the views and at least one navigation link, each navigation link specifying a potential transition from a first view in the set of views to a second view in the set of views; and
storing the view composition in a repository.

29. An apparatus comprising:
means for receiving user input specifying a view composition, the view composition comprising a set of views, each view in the set of views comprising a layout of one or more user interface elements selected from a set of user interface elements, the view composition further comprising a layout of the views and at least one navigation link, each navigation link specifying a potential transition from a first view in the set of views to a second view in the set of views; and
means for storing the view composition in a repository.

30. A computer-implemented method for executing an application, the method comprising:
generating a user interface comprising a layout of one or more views from a set a views, the layout and the set of views being specified in a view composition, each view in the set of views comprising a layout of one or more user interface elements selected from a set of user interface elements; and
modifying the user interface based on at least one navigation link specified in the view composition, wherein each navigation link associates a first view in the set of views with a second view in the set of views.

31. An apparatus comprising:
means for generating a user interface comprising a layout of one or more views from a set a views, the layout and the set of views being specified in a view composition, each view in the set of views comprising a layout of one or more user interface elements selected from a set of user interface elements; and
means for modifying the user interface based on at least one navigation link specified in the view composition, wherein each navigation link associates a first view in the set of views with a second view in the set of views.
